(19) United States
(12) Patent Application Publication
(10) Pub. No.: US 2023/0141464 A1
(43) Pub. Date: May 11, 2023

(54) INFORMATION PROCESSING SYSTEM, INFORMATION PROCESSING APPARATUS, AND NON-TRANSITORY COMPUTER READABLE MEDIUM STORING PROGRAM

(71) Applicant: FUJIFILM Business Innovation Corp., Tokyo (JP)

(72) Inventor: Yoshitomo MINAMI, Kanagawa (JP)

(73) Assignee: FUJIFILM Business Innovation Corp., Tokyo (JP)

(21) Appl. No.: 17/737,976

(22) Filed: May 5, 2022

(30) Foreign Application Priority Data
Nov. 5, 2021 (JP) 2021-181341

(51) Int. Cl. H04N 1/34; H04N 1/00

(52) U.S. Cl. CPC H04N 1/344; H04N 1/00334; H04N 1/346

(57) ABSTRACT

An information processing system includes a code assignment section that makes a document with code by assigning a code image to a first electronic document, the code image including billing destination information for determining a billing destination of a fee for reading the document with code, a printing section that prints the document with code as a paper document, a reading section that reads the document with code to generate a corresponding second electronic document, and transmits the second electronic document to a designated transmission destination, a code reading section that reads information from the code image in a case where the document with code is read by the reading section, and a billing section that performs billing to the billing destination for the fee for reading based on the billing destination information read by the code reading section.

### CROSS-REFERENCE TO RELATED APPLICATIONS

This application is based on and claims priority under 35 USC 119 from Japanese Patent Application No. 2021-181341 filed Nov. 5, 2021.

### BACKGROUND

### (i) Technical Field

The present invention relates to an information processing system, an information processing apparatus, and a non-transitory computer readable medium storing a program.

### (ii) Related Art

JP04848207B discloses a document management system including a printing section that prints a page for automatic registration operation instruction to an existing system in order to support a work of digitizing a paper document and registering the digitized paper document in the existing system and to contribute to labor saving, a data accepting section that accepts scan data including an image of a paper on which the page for automatic registration operation instruction is printed, an information acquisition section that extracts a part of the page for automatic registration operation instruction from the scan data and acquires identification code information, and a registration section that registers parts of the scan data other than the page for automatic registration operation instruction in the existing system according to the identification code information.

JP2005-109497A discloses a facsimile transmission system including a facsimile apparatus that, in order to cause a transmission destination to pay only a fee for a specific manuscript, transmits a cash on delivery transmission code to a management server to inquire about whether or not cash on delivery is possible in a case where the cash on delivery transmission code is extracted from an image obtained by reading the manuscript, and executes current facsimile transmission by the cash on delivery and transmits a usage fee in a case where a determination result of the management server is permitted; and the management server that charges a refund of the usage fee to a relevant charging destination based on billing information.

### SUMMARY

An image processing apparatus installed in a store or the like provides a printing service for printing an electronic document as a paper document, and a reading service for reading the paper document to convert the paper document into the electronic document, and transmitting the electronic document to a designated transmission destination. For example, a user of the image processing apparatus uses the printing service to print content stored in the server apparatus. Then, after filling in the content in the printed content, the content is read by using the reading service, transmitted to a content provider, and submitted.

In such a usage pattern, there may be a case where the fees for the printing service and the reading service, which are normally billed to the user, is billed to a billing destination different from the user. For example, there may be a case of paying the fees with the content provider as the billing destination. Here, as for the fee for the printing service, for example, billing to the content provider is performed by acquiring information on the billing destination from a server in which the content is stored. However, as for the fee for the reading service, the information on the billing destination cannot be obtained by the same method as in the printing service, so that the billing to the content provider is not performed. Therefore, for example, the user charges a refund to the content provider after reimbursing the fee for the reading service, so that the user requires time and effort.

Aspects of non-limiting embodiments of the present disclosure relate to an information processing system, an information processing apparatus, and a non-transitory computer readable medium storing a program that reduce time and effort of a user, compared with a case where information for determining a billing destination of a fee for reading is not assigned to a paper document to be printed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a code assignment section that makes a document with code by assigning a code image to a first electronic document, the code image including billing destination information for determining a billing destination of a fee for reading the document with code, a printing section that prints the document with code as a paper document, a reading section that reads the document with code to generate a corresponding second electronic document, and transmits the second electronic document to a designated transmission destination, a code reading section that reads information from the code image in a case where the document with code is read by the reading section, and a billing section that performs billing to the billing destination for the fee for reading based on the billing destination information read by the code reading section.

### BRIEF DESCRIPTION OF THE DRAWINGS

Exemplary embodiment(s) of the present invention will be described in detail based on the following figures, wherein:

FIG. 1 is a diagram showing an example of an overall configuration of an information processing system to which the present exemplary embodiment is applied;

FIG. 2 is a block diagram showing an example of a hardware configuration of an image processing apparatus according to the present exemplary embodiment;

FIG. 3 is a block diagram showing an example of a hardware configuration of a server apparatus according to the present exemplary embodiment;

FIG. 4 is a block diagram showing an example of a functional configuration of the image processing apparatus according to the present exemplary embodiment;

FIG. 5 is a block diagram showing an example of a functional configuration of the server apparatus according to the present exemplary embodiment;

FIG. 6 is a sequence chart showing an example of a processing procedure related to a printing service;

FIG. 7 is a sequence chart showing an example of a processing procedure related to a scanning service; and

FIGS. 8A and 8B are diagrams explaining assignment of a code image, FIG. 8A is print data before the code image is assigned, and FIG. 8B is coded print data to which the code image is assigned.

### DETAILED DESCRIPTION

Hereinafter, an exemplary embodiment of the present invention (hereinafter, may be referred to as “the present exemplary embodiment”) will be described with reference to the accompanying drawings.

Overall Configuration of Information Processing System 1

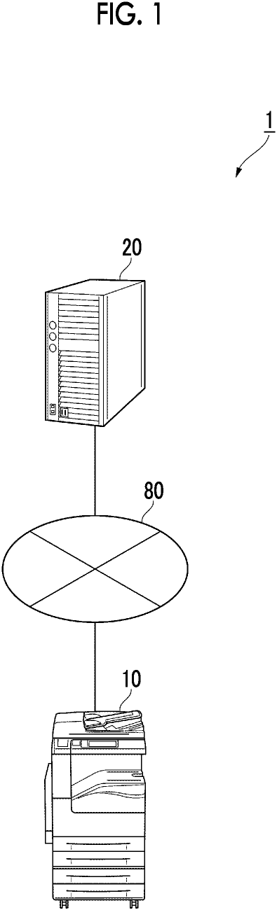

FIG. 1 is a diagram showing an example of an overall configuration of an information processing system 1 to which the present exemplary embodiment is applied.

As shown in FIG. 1, the information processing system 1 is configured in such a way that an image processing apparatus 10 that is used by an unspecified number of users and a server apparatus 20 that manages various data processed by the image processing apparatus 10 are connected to each other via a communication line 80. The communication line 80 is, for example, a line such as the Internet, and is used for information communication between the image processing apparatus 10 and the server apparatus 20.

In the present exemplary embodiment, “print data” is an electronic document to be provided to the user by being stored in the server apparatus 20, and is an example of a first electronic document provided via the communication line 80. The print data may include an image other than text, or may include only an image without containing text. Further, an aspect, such as the number of pages or a page size, is not particularly limited.

The image processing apparatus 10 is an apparatus that prints the print data registered in the server apparatus 20 based on an instruction of the user, reads a paper document based on the instruction of the user, and generates relevant scan data. The “scan data” is an example of a second electronic document according to the present exemplary embodiment.

The image processing apparatus 10 according to the present exemplary embodiment is a so-called multifunction apparatus that provides, for example, various image processing functions, such as a printing function, an image reading (scanning) function, a copying function, and a facsimile function, based on the instruction of the user.

The server apparatus 20 is an information processing apparatus that manages the print data to be printed by the image processing apparatus 10 and the scan data generated by the image processing apparatus 10. As an example of the management, the server apparatus 20 transmits the print data designated by the user to the image processing apparatus 10. Further, for example, the server apparatus 20 receives the scan data generated by the image processing apparatus 10 and transmits the scan data to a designated transmission destination. The transmission destination is designated by an aspect such as a mail or a Peer-To-Peer (P2P) address, or a path of a storage place (folder) provided by the server apparatus 20 or another server apparatus.

The server apparatus 20 according to the present exemplary embodiment manages, for example, an electronic document provided by a provider including a corporation, such as a company or a university, an organization or a group, or an individual, as the print data. Further, the server apparatus 20 according to the present exemplary embodiment stores and manages various information registered in association with the print data by the provider of the print data. The information registered by the provider (hereinafter, may be referred to as “provider registration information”) is, for example, a provider ID for identifying the provider and a transmission destination information for designating a transmission destination of the scan data. Further, the information is, for example, billing restriction information for determining whether or not to cause printing of the print data or scanning of a paper document on which the print data is printed to be a target of billing to a billing destination. Further, the information is, for example, information for determining whether or not to allow the user to print the print data, deadline information as a deadline for accepting transmission of the scan data to the designated transmission destination, and the like.

The billing restriction information, the deadline information, and the transmission destination information are examples of attribute information indicating attributes of the print data, the paper document on which the print data is printed, or the scan data obtained by scanning the paper document.

Here, the print data provided by the provider is, for example, a questionnaire, an application form, an interview sheet, an application document, a task, or the like, and various types of content expected to be printed by the user, edited by filling in content, and submitted to the provider. The print data is provided via the communication line 80 by a computer (not shown) or the like used by the provider.

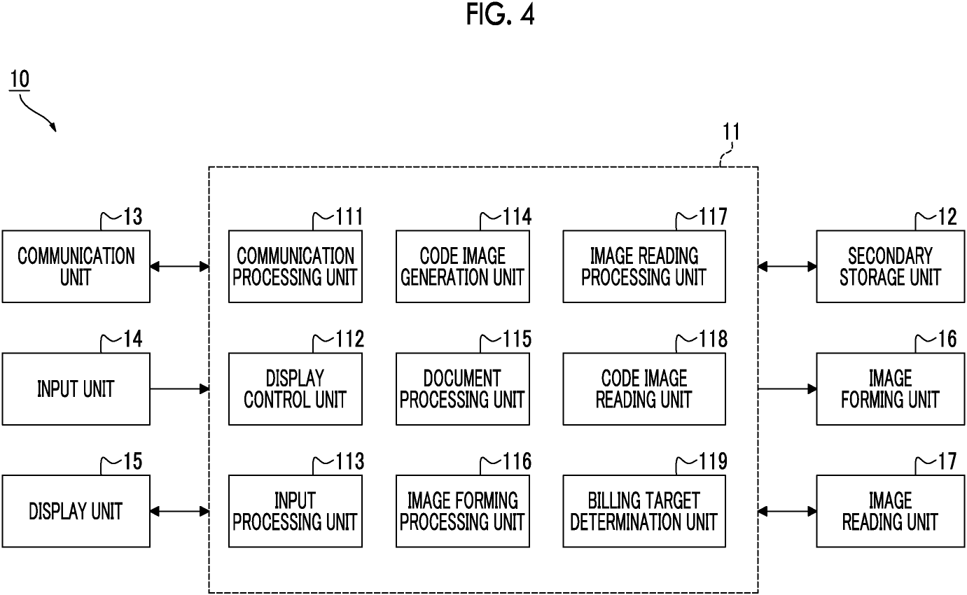

Further, the server apparatus 20 according to the present exemplary embodiment manages billing related to usage fees of the various image processing functions of the image processing apparatus 10. As a specific example, in a case where the user uses the printing function and the scanning function of the image processing apparatus 10, the server apparatus 20 determines a billing destination for performing billing on a fee for printing and a fee for scanning, and performs the billing. Details of determination of the billing destination and billing processing will be described later with reference to FIGS. 4 to 8.

The information processing system 1, to which the present exemplary embodiment is applied, provides various image processing functions by the image processing apparatus 10 and manages the billing by the server apparatus 20, thereby providing various image processing services to the user. As a specific example, as a printing service, the information processing system 1 provides the printing function of printing the print data according to the billing of the fee for printing. In addition, as a scanning service, the information processing system 1 provides the scanning function of generating the scan data obtained by reading the paper document and transmitting the scan data to the designated transmission destination according to the billing of the fee for scanning.

Further, in the information processing system 1 to which the present exemplary embodiment is applied, the various image processing functions described above can be used in such a way that the user directly pays the usage fee instead of the billing to the billing destination. The user pays the usage fee by using, for example, a money processing apparatus (not shown) attached to the image processing apparatus 10.

In the present exemplary embodiment, the fee for printing and the fee for scanning are determined according to the number of pages and the data size of a document to be printed or scanned.

Hardware Configuration of Image Processing Apparatus 10

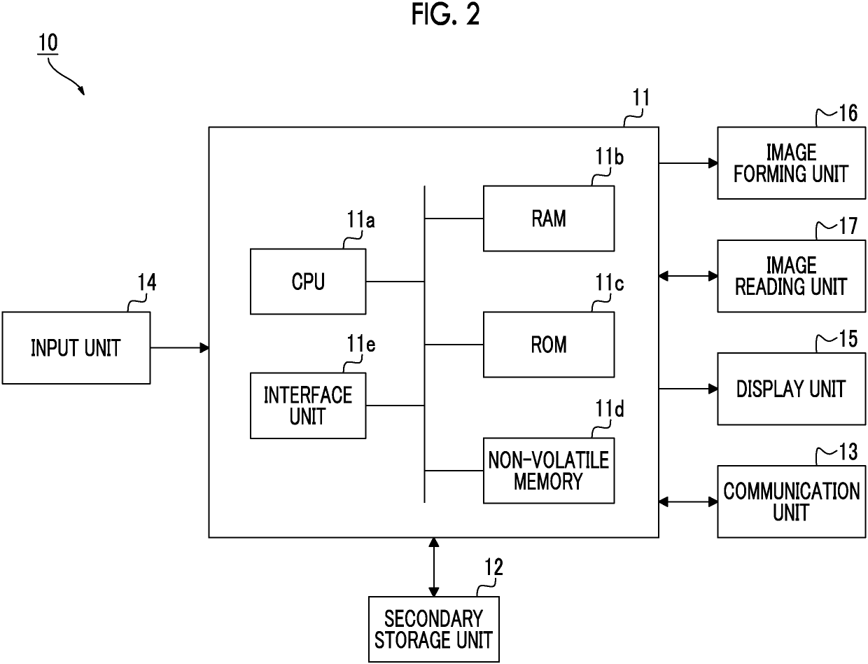

FIG. 2 is a block diagram showing an example of a hardware configuration of the image processing apparatus 10 according to the present exemplary embodiment. The image processing apparatus 10 according to the present exemplary embodiment is an example of an information processing apparatus, and includes an arithmetic processing unit 11 that executes digital arithmetic processing according to a predetermined image processing program in a case of printing the print data and generating the scan data, a secondary storage unit 12 that is realized by, for example, a Hard Disk Drive (HDD) in which various data are recorded, and a communication unit 13 that transmits and receives information via the communication line 80 (refer to FIG. 1). In addition, the image processing apparatus 10 includes an input unit 14, such as keys, a touch panel, and a card reader, that accepts an input operation from the user, a display unit 15, such as a liquid crystal display panel or an organic Electro Luminescence (EL) display panel, that displays an image, text information, or the like to the user, an image forming unit 16 that realizes the printing function, and an image reading unit 17 that realizes the scanning function.

The arithmetic processing unit 11 includes a Central Processing Unit (CPU) 11a that controls an entire apparatus as an example of a processor, a Random Access Memory (RAM) 11b that is used as a working memory or the like of the CPU 11a, and a Read Only Memory (ROM) 11c that stores an image processing program or the like executed by the CPU 11a. Further, the arithmetic processing unit 11 includes a non-volatile memory 11d that is rewritable and capable of holding data even in a case where the power supply is cut off, and an interface unit 11e that controls each unit such as the input unit 14 connected to the arithmetic processing unit 11. The non-volatile memory 11d is configured by, for example, an SRAM or a flash memory backed up by a battery. Further, the secondary storage unit 12 stores various data and the like, and stores the image processing program executed by the arithmetic processing unit 11. In a case where the arithmetic processing unit 11 reads the image processing program stored in the secondary storage unit 12, each processing of the image processing apparatus 10 of the present exemplary embodiment is executed.

The image forming unit 16 is configured by a printer engine such as a laser printer or an ink jet printer, forms an image on a recording material, such as paper, in response to an instruction from the arithmetic processing unit 11, and outputs the formed image. The image forming unit 16 according to the present exemplary embodiment realizes the printing function by forming content of the print data on the paper and generating the print data as the paper document.

The image reading unit 17 is configured by an image scanner or the like, reads the image formed on the recording material, such as paper, in response to the instruction from the arithmetic processing unit 11, and outputs relevant electronic data. The image reading unit 17 according to the present exemplary embodiment realizes the scanning function by reading the content formed on the paper on each page of the set paper document and generating the scan data. The paper document set to be read in the image reading unit 17 may be referred to as a “manuscript”.

### Hardware Configuration of Server Apparatus 20

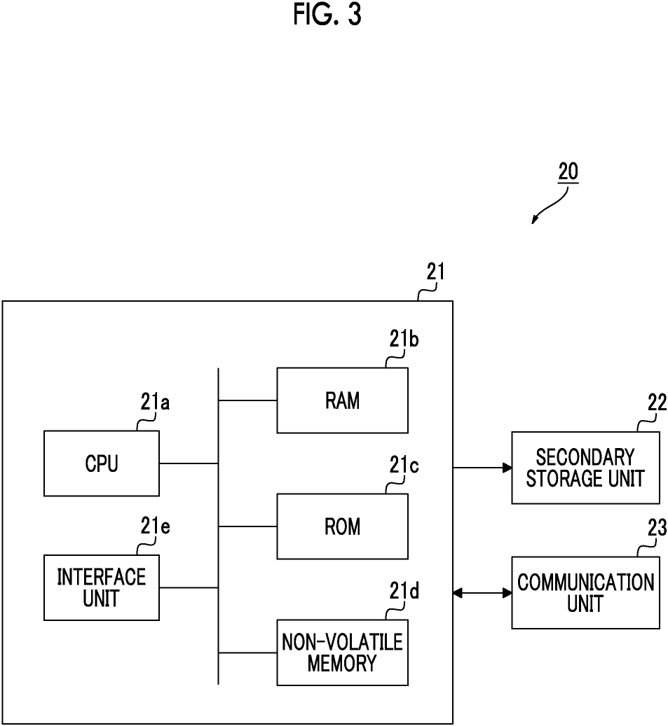

FIG. 3 is a block diagram showing an example of a hardware configuration of the server apparatus 20 according to the present exemplary embodiment. The server apparatus 20 according to the present exemplary embodiment is an example of an information processing apparatus, and includes an arithmetic processing unit 21 that executes digital arithmetic processing according to a predetermined management program in a case of managing the print data and the scan data and managing the billing, a secondary storage unit 22 that is realized by, for example, a Hard Disk Drive (HDD) in which files, reservation information, and the like are recorded, and a communication unit 23 that transmits and receives information via the communication line 80 (refer to FIG. 1).

The arithmetic processing unit 21 includes a CPU 21a that controls an entire apparatus as an example of a processor, a RAM 21b that is used as a working memory or the like of the CPU 21a, and a ROM 21c that stores a management program executed by the CPU 21a. Further, the arithmetic processing unit 11 includes a non-volatile memory 21d that is rewritable and can hold data even in a case where the power supply is cut off, and an interface unit 21e that controls each unit such as the communication unit 23 connected to the arithmetic processing unit 21. The non-volatile memory 21d is configured by, for example, an SRAM or a flash memory backed up by a battery. Further, the secondary storage unit 22 stores the print data, the scan data, and the like, and stores the management program executed by the arithmetic processing unit 21. In a case where the arithmetic processing unit 21 reads the management program stored in the secondary storage unit 22, each processing of the server apparatus 20 of the present exemplary embodiment is executed.

Here, the various programs executed by the CPUs 11a and 21a as an example of the processor are provided to the arithmetic processing units 11 and 21 in a state of being stored in a computer-readable recording medium such as a magnetic recording medium (a magnetic tape, a magnetic disk, or the like), an optical recording medium (an optical disk or the like), a magneto-optical recording medium, or a semiconductor memory. Further, the program executed by the CPUs 11a and 21a may be downloaded to the image processing apparatus 10 or the server apparatus 20 by using communication means such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Functional Configuration of Image Processing Apparatus 10

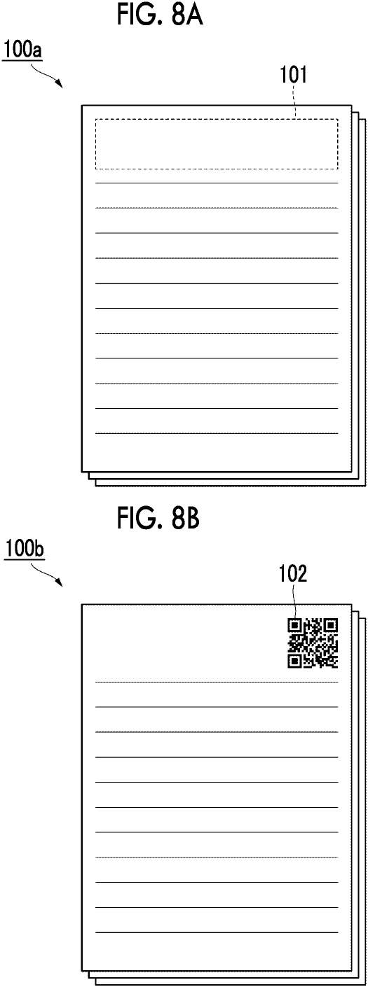

Next, a functional configuration of the image processing apparatus 10 will be described with reference to FIG. 4 and FIGS. 8A and 8B.

FIG. 4 is a block diagram showing an example of the functional configuration of the image processing apparatus 10 according to the present exemplary embodiment. The image processing apparatus 10 includes a communication processing unit 111, a display control unit 112, an input processing unit 113, a code image generation unit 114, a document processing unit 115, an image forming processing unit 116, an image reading processing unit 117, a code image reading unit 118, and a billing target determination unit 119, which are realized by the arithmetic processing unit 11 shown in FIG. 2.

FIGS. 8A and 8B are diagrams explaining assignment of a code image 102, FIG. 8A is print data 100a to which the code image 102 is not assigned, and FIG. 8B is coded print data 100b to which the code image 102 is assigned.

The communication processing unit 111 processes information transmitted or received by the communication unit 13. For example, the communication processing unit 111 performs processing of receiving various requests for the server apparatus 20 based on an operation of the user and various information transmitted from the server apparatus 20 in response to the requests. The request is, for example, a request to transmit the print data designated by the user, the provider registration information associated with the print data, billing destination information, and the like. Further, for example, the communication processing unit 111 performs processing of transmitting scan data generated by the image reading processing unit 117, user input information input by the user, and the like to the server apparatus 20.

The display control unit 112 controls the type and content of an image, various icons, text, or the like displayed on the display unit 15, and controls a display aspect such as a location or a size of the image to be displayed.

For example, the display control unit 112 controls to display a list of various image processing functions (services) provided by the image processing apparatus 10 as an operation screen for accepting designation (selection) of a function to be used from the user. Further, as an operation screen for accepting the designation (selection) of the print data to be printed from the user, the display control unit 112 controls to display print data that is allowed to be printed by the user as a list of text, thumbnail images, or the like among the print data managed by the server apparatus 20. Further, as a notification to the user, the display control unit 112 controls to display progress situations and results of various processing in the image processing apparatus 10 or the server apparatus 20 by text or the like.

The input processing unit 113 performs various operations input by the user via the input unit 14 and performs processing on information. The input processing unit 113 performs processing by accepting, for example, an operation of designating (selecting) a function or print data to be used by the user via the input unit 14, such as a touch panel or keys. Further, information read from an ID card (an employee ID, a student ID, or the like) by the input unit 14, such as a card reader, and information input via the input unit 14, such as a touch panel or keys, are associated as the user input information for designated print data. For example, the user input information is user identification information, such as a name of the user, a student ID number as the user ID, or an employee number, for identifying the user.

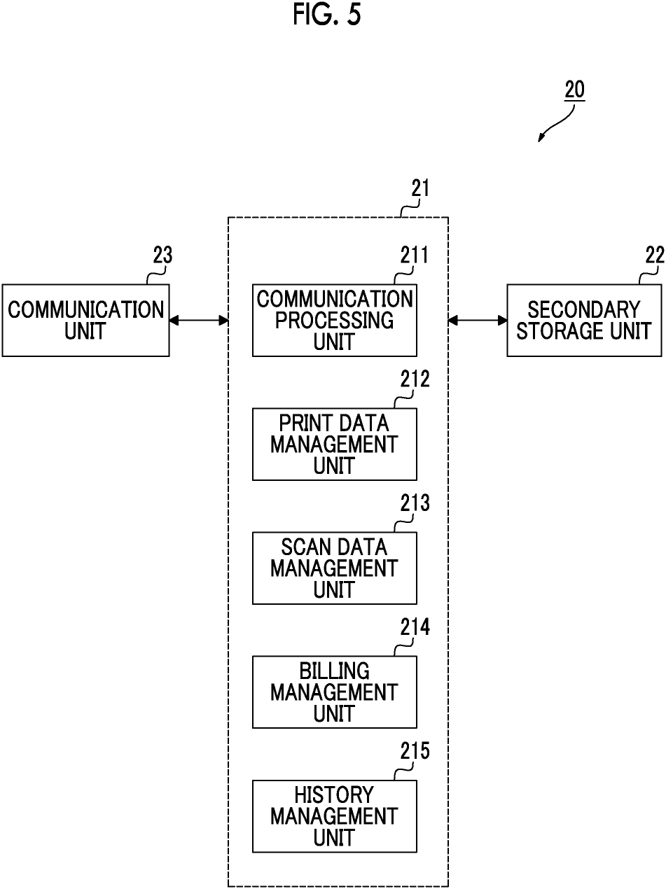

The code image generation unit 114 generates the code image 102 to be assigned to the print data in a case where the print data is printed. More specifically, the code image generation unit 114 generates the code image 102 including the information received from the server apparatus 20 together with the print data, the user input information, and the billing destination information (described later with reference to FIG. 5) for determining the billing destination of the fee for printing and the fee for scanning. Further, the code image 102 according to the present exemplary embodiment includes, as the attribute information, a print job ID (described later) issued by the image forming processing unit 116, information on a date and time at which printing is executed, information on a store in which the image processing apparatus 10 is installed, apparatus identification information for identifying the image processing apparatus 10 that has executed printing, and the like.

Here, the code image 102 is an image in which some information is coded, and may be a bar code, a QR code (registered trademark), or the like. Further, in a case where the image processing apparatus 10 has a so-called Optical Character Recognition (OCR) function, the code image 102 may be a text string configured with alphabets, numbers, or the like.

The document processing unit 115 performs processing, such as duplication, deletion, and editing (changing) content, on the electronic document such as the print data received from the server apparatus 20 and the scan data generated by the image reading processing unit 117. For example, the document processing unit 115 performs processing of assigning the code image 102 generated by the code image generation unit 114 to the print data before being printed, and obtaining the coded print data.

Here, the assignment of the code image 102 to the print data may be performed by an aspect of pasting the code image 102 to a page configuring the print data or by an aspect of preparing a new page including the code image 102 in the print data. In a case where the print data is composed of a plurality of pages, printing may be performed only on a specific page such as a first page, or printing may be performed on all pages. A configuration may be provided in which the provider or the user can select any of the aspects. In the present exemplary embodiment, an aspect may be performed in which the code image 102 is pasted to all the pages configuring the print data.

The assignment of the code image 102 according to the present exemplary embodiment will be described more specifically with reference to FIGS. 8A and 8B. First, the document processing unit 115 specifies an empty area 101 (area shown by a broken line in FIG. 8A) in which text, an image, or the like does not exist in the print data 100a before the code image 102 shown in FIG. 8A is assigned. Then, in a case where a size of the empty area 101 is equal to or larger than a size of the code image 102, the code image 102 is pasted to the empty area 101 as shown in FIG. 8B and is set as the coded print data 100b. In a case where the size of the empty area 101 is smaller than the size of the code image 102, the code image 102 is pasted after being reduced to a size that fits in the empty area 101.

The image forming processing unit 116 performs processing related to an image forming function realized by the image forming unit 16. More specifically, the image forming processing unit 116 according to the present exemplary embodiment receives the print data from the server apparatus 20, controls the image forming unit 16 to print the coded print data after the code image 102 is assigned to the print data to obtain the coded print data, and outputs a document with code, which is the paper document to which the code image 102 is assigned.

Further, the image forming processing unit 116 issues a different print job ID each time printing is performed. For example, even in a case where the same print data is printed a plurality of times by the same user, the image forming processing unit 116 distinguishes respective print processing and issues different print job IDs.

The image reading processing unit 117 performs processing related to an image reading function realized by the image reading unit 17. More specifically, in a case where the scanning service is selected and scan is instructed by the user, the image reading processing unit 117 according to the present exemplary embodiment controls the image reading unit 17 to execute reading of the set manuscript, thereby generating relevant scan data.

The code image reading unit 118 extracts and decodes the code image 102 from the scan data generated by the image reading processing unit 117 to acquire information included in the code image 102. Further, the code image reading unit 118 performs processing of associating the information acquired by decoding with the original scan data.

The billing target determination unit 119 determines whether or not current printing or scanning by the user who uses the image processing apparatus 10 is the target of the billing to the billing destination. For example, in a case where conditions, which are related to the user input information input in a case where the user uses the printing service, the deadline information received from the server apparatus 20, and the billing restriction information, are satisfied, the current printing is determined to be the target of the billing to the billing destination. Further, for example, in a case where the user uses the scanning service and a predetermined billing condition related to the document with code, which is the manuscript, or the scan data is satisfied, the current scan is determined as the target of the billing to the billing destination.

Further, the billing target determination unit 119 sorts data to be a target of the transmission to the designated transmission destination and to be a target of the billing to the billing destination from the scan data. The billing target determination unit 119 according to the present exemplary embodiment sorts only the page to which the code image 102 is assigned from the scan data generated by the image reading processing unit 117 as the target of the billing. Then, the amount to be billed to the billing destination is determined according to the number of sorted pages of the target of the billing, the data size, and the like, and the information is associated with the scan data. In addition, pages that are not the target data are excluded from the scan data, and resulting scan data is used as scan data (for transmission) to be transmitted to the transmission destination.

### Functional Configuration of Server Apparatus 20

Next, a functional configuration of the server apparatus 20 will be described.

FIG. 5 is a block diagram showing an example of the functional configuration of the server apparatus 20 according to the present exemplary embodiment. The server apparatus 20 includes a communication processing unit 211, a print data management unit 212, a scan data management unit 213, a billing management unit 214, and a history management unit 215, which are realized by the arithmetic processing unit 21 shown in FIG. 3.

The communication processing unit 211 performs processing on the information transmitted or received by the communication unit 23. For example, the communication processing unit 211 performs processing of receiving various requests from the image processing apparatus 10 and transmitting various information to the image processing apparatus 10 in response to the requests. The information to be transmitted to the image processing apparatus 10 is, for example, the designated print data, the provider registration information associated with the print data, the information related to the billing managed by the billing management unit 214, and various histories managed by the history management unit 215. Further, the communication processing unit 211 according to the present exemplary embodiment receives the print data and the provider registration information from a computer or the like used by the provider, and causes the print data management unit 212 to manage the print data and the provider registration information.

The print data management unit 212 manages the print data provided by the provider and the provider registration information associated with the print data. In a case wherever the print data is provided from the provider, the print data management unit 212 according to the present exemplary embodiment performs management by assigning a print data ID, which is a number for identification, to the print data. Further, in a case where the communication processing unit 211 receives a print data transmission request from the image processing apparatus 10, the print data management unit 212 extracts the designated print data and necessary information in the provider registration information from the storage unit 22, and causes the communication processing unit 211 to transmit the extracted print data and necessary information.

The scan data management unit 213 manages the scan data received from the image processing apparatus 10 and various information received together with the scan data. In the present exemplary embodiment, together with the scan data, the user input information input in a case of using the scanning service, various information read by the code image reading unit 118, and information on the amount to be billed to the billing destination determined by the billing target determination unit 119, so that the information are associated with each other and managed.

The billing management unit 214 manages the billing destination set by the provider. There are various billing destinations depending on billing methods, but, for example, the billing destinations, such as a payment service of a credit card or an electronic money, or a bank account, at which processing of paying the fees is possible according to billing processing of the billing management unit 214, are set in an aspect of registration information of the payment service such as a credit card number, account information, or tokens corresponding to the information. The billing management unit 214 may issue a different billing destination ID for each set billing destination and use the billing destination ID for management.

For example, the billing destination is set and applied for each print data in a case where the provider provides the print data. Further, for example, a billing destination preset for each provider is applied to the print data provided by the provider.

Further, in a case where the billing destination information is requested by the image processing apparatus 10, the billing management unit 214 transmits various information managed by the server apparatus 20 as the billing destination information.

Further, the billing management unit 214 determines the billing destination based on the billing destination information and performs billing processing to the determined billing destination. More specifically, the billing management unit 214 according to the present exemplary embodiment determines the billing destination of the fee for printing the manuscript of the scan data and the fee for scanning based on the billing destination information received from the image processing apparatus 10 together with the scan data, and executes the billing processing to the determined billing destination.

Furthermore, the billing management unit 214 determines whether or not the scan data received from the image processing apparatus 10 is the target of the billing to the billing destination. More specifically, the billing management unit 214 according to the present exemplary embodiment determines that the scan data is the data which is the target of the billing to the billing destination in a case where the predetermined billing condition related to the scan data is satisfied.

For example, the billing management unit 214 determines whether or not the billing condition relating to the degree of similarity between the print data identified by the print data ID read from the code image 102 included in the scan data and the scan data is satisfied. Usually, the print data and the scan data include common text and images, so that there is a high probability of having a certain degree of similarity. Therefore, in a case where the degree of similarity is extremely low, a paper document that does not correspond to the print data is scanned as a manuscript, so that billing which is not intended by the provider may be performed on a fee for reading the paper document. Therefore, for example, the target of the billing to the billing destination is determined on the billing condition that the degree of similarity between the print data and the scan data exceeds a predetermined threshold value, so that billing, which is not intended by the provider, for reading the paper document is suppressed. On the other hand, in a case where the degree of similarity is extremely high, there is a possibility that the user has not edited the paper document, so that, in this case as well, billing which is not intended by the provider may be performed. In order to suppress such a case, a fact that the degree of similarity between the print data and the scan data is equal to or lower than the predetermined threshold value may be the billing condition.

The above-described condition relating to the degree of similarity is an example, and other conditions may be used as the billing condition. For example, a fact that the number of pages of scan data, a data size, and the like are equal to or less than the predetermined threshold value or exceed the threshold value may be the billing condition.

The threshold values such as the degree of similarity, the number of pages, and the data size used by the billing management unit 214 may be predetermined by the provider as the provider registration information.

The history management unit 215 manages print history and scan history of the image processing apparatus 10 and transmission history of scan data of the server apparatus 20 for each print data and each user. More specifically, based on acceptance of the print data transmission request from the image processing apparatus 10, transmission of the print data to the image processing apparatus 10, and reception of a notification of print completion from the image processing apparatus 10, the history management unit 215 according to the present exemplary embodiment organizes the date and time and the number of times by the print data ID and the user ID for management as the print history. Further, based on the reception of the scan data from the image processing apparatus 10, the history management unit 215 organizes the date and time and the number of times by the print data ID and the user ID for management as the scan history. Further, based on the fact that the communication processing unit 211 has transmitted the scan data to the designated transmission destination, the history management unit 215 organizes the date and time and the number of times by the print data ID and the user ID for management as a transmission history.

### Processing Related to Service Usage and Billing

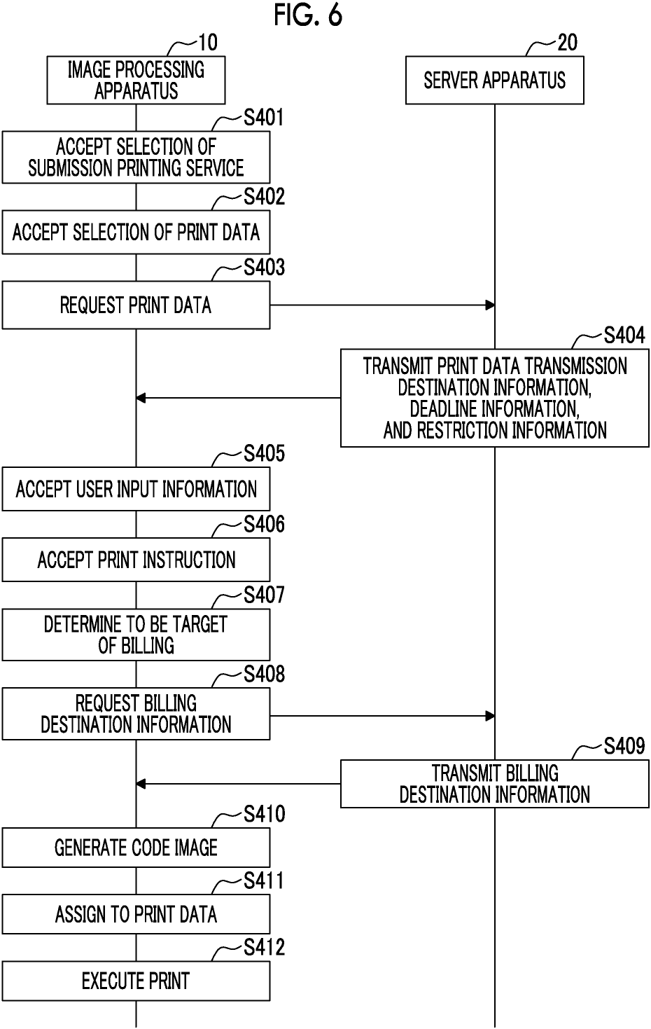

Next, processing related to usage of the printing service and the scanning service and the billing in the information processing system 1 to which the present exemplary embodiment is applied will be described with reference to FIG. 6 and FIGS. 8A and 8B.

FIG. 6 is a sequence chart showing an example of a processing procedure related to the printing service.

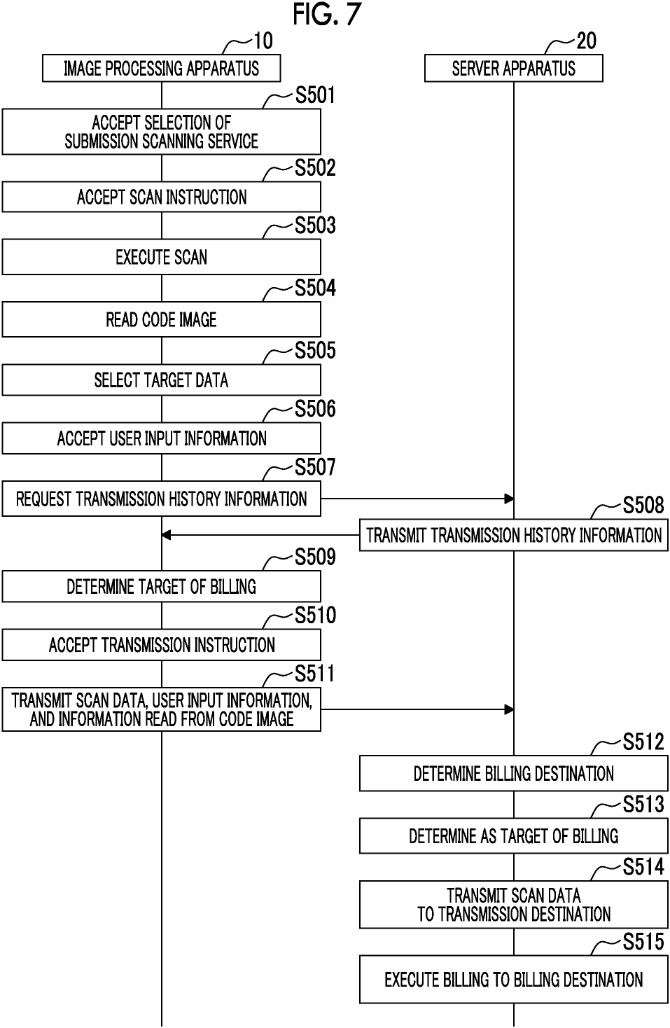

FIG. 7 is a sequence chart showing an example of the processing procedure related to the scanning service.

Hereinafter, a case where the user of the image processing apparatus 10 is a university student, the provider of the print data is the university where the user is enrolled, and the provided print data is a task A-1 in a class A of the university will be described as an example. In this example, the user acquires a paper document on which the task is printed by using the image processing apparatus 10 installed in a store such as a convenience store, and fills in the answer. Then, the paper document after filling out is scanned using the image processing apparatus 10 and transmitted (submitted) to the university. Further, the transmission (submission) to the university is performed by storing the paper document in a folder provided by the server apparatus 20, that is, a folder A to which the staff of the university has access authority. In other words, the folder A is designated as the transmission destination by the university that is the provider.

In the example described below, a service that provides the printing function or the scanning function according to the billing to the billing destination is referred to as a “submission printing service” or a “submission scanning service”, and the service that provides the printing function or the scanning function according to the payment of the fees by the user is referred to as a “normal printing service” or a “normal scanning service” for distinction. In a case where the printing service or the scanning service is used by using the image processing apparatus 10, the user selects and uses either the printing service or the scanning service.

### Printing of Document With Code

First, the user prints the task A-1 by using the printing service.

With reference to FIG. 6, in step S401, the input processing unit 113 (refer to FIG. 4) accepts the selection (designation) of the submission printing service by the user. As a more specific example, in the image processing apparatus 10, two buttons for respectively designating the “submission printing service” and the “normal printing service” on a touch panel as an example of the input unit 14 and the display unit 15 are displayed, and a fact that a button of the “submission printing service” is pressed is accepted as the selection of the submission printing service.

In step S402, the input processing unit 113 accepts the selection (designation) of the print data to be the target of a subsequent print processing. For example, a different number (hereinafter, referred to as a “reservation number”) is set for each of the print data managed by the server apparatus 20, and input of the reservation number by the user is accepted as the selection of the corresponding print data. As a more specific example, in a case where the provider provides the print data, a multi-digit alphanumerical text is set as the reservation number. Then, the set reservation number is notified to the provider, and the provider informs the user of the notified reservation number. The user designates the corresponding print data by inputting the reservation number transmitted from the provider into the image processing apparatus 10. The reservation number may be randomly set by the print data management unit 212 or the like, or may be input by the provider. Further, a print ID may be used as the reservation number.

An aspect of selecting the print data is not limited to the input of the reservation number. For example, a list of print data file names managed by the server apparatus 20 may be displayed on the touch panel, and a fact that any file name is designated may be accepted as the selection of the print data.

In a case where there is print data that the provider allows only a specific user to print, an aspect may be performed in which the student ID card (an example of an ID card) of the user is read or input of the student ID number (an example of a user ID) is accepted before step S402, and a list of print data allowed to the user is displayed. As a more specific example, in a case where only students who are taking the class A at the university are allowed to print the task A-1, whether or not the user is taking the class A is determined based on the student ID number, and the task A-1 may be displayed in the list of print data according to the determination that the student has taken the class A.

In step S403, the communication processing unit 111 (refer to FIG. 4) requests the server apparatus 20 for the print data selected by the user. In this example, the print data of the task A-1 is requested.

In step S404, the print data management unit (refer to FIG. 5) extracts the transmission destination information, the deadline information, and the restriction information together with the print data of the designated task A-1 in response to the request from the image processing apparatus 10, and transmits the information to the image processing apparatus 10 via the communication processing unit 211. As a more specific example, the transmission destination information that designates the folder A as the transmission destination in a case where the task A-1 is submitted, print deadline information indicating the print deadline of the task A-1, submission deadline information indicating the deadline of the transmission (submission) of the task A-1, user billing restriction information that restricts billing for printing or scanning by a user who has not taken the class A, and multiple billing restriction information that restricts the billing for scanning whose number of times exceeds the specified number of times by the same user are extracted and transmitted, together with the print data. The transmission destination information, the deadline information, and the billing restriction information are registered as the provider registration information in a case where the print data of the task A-1 is provided from the university.

In step S405, the input processing unit 113 accepts the input of the student ID number of the user and unique password of the user as the user input information. The user input information is information that functions as information indicating that printing has been instructed by the user who made the input, and is an example of attribute information indicating attributes of the paper document output in step S412 described later. As described above, in a case where the student ID number or the like is accepted before step S402, step S405 may be skipped.

In step S406, the input processing unit 113 accepts a print instruction from the user. More specifically, together with a file name (“task A-1” in this example) and a thumbnail image of the print data selected on the touch panel, various user input information is displayed, and text inquiring whether or not there is an error in the selected print data or the input content and various buttons for accepting an answer of the user are displayed. In a case where there is no error in the displayed content, the user presses a “print execution” button and gives the print instruction. In a case where there is an error, the user presses a “cancel” button or a “correction” button to cancel printing or correct the input content.

In step S407, the billing target determination unit 119 (refer to FIG. 4) refers to the information received from the server apparatus 20, and, in a case where the current printing and the scanning of the paper document output by the printing satisfy the condition, the billing target determination unit determines the target of the billing to the billing destination. More specifically, in a case where the billing target determination unit 119 refers to the billing restriction information for each user and the user specified by the user input information is a student of the class A, the billing target determination unit 119 determines that the printing and scanning of the task A-1 by the user is the target of the billing. Further, based on the print deadline information, it is determined that a date on which printing is instructed is before the print deadline and the printing and scanning is the target of the billing.

In a case where it is determined in step S407 that the current printing and scanning are not the target of the billing to the billing destination, a fact that the current printing and scanning are not the target of the billing to the billing destination is notified to the user by displaying, for example, text, and the process ends. Further, for example, the process is shifted to the normal printing service, the fee for printing is charged to the user, and the printing function is provided according to a case where the payment is made. In a case of shifting to the normal printing service, the code image 102, which will be described later, is not generated (step S410) and is not assigned to the print data (step S411).

In step S408, the communication processing unit 111 requests the server apparatus 20 for the billing destination information of the fee for current printing and scanning of the paper document output by the printing.

In step S409, the communication processing unit 211 transmits the billing destination information requested by the image processing apparatus 10. In this example, the university which is the provider sets a withdrawal account of the university (account number account 1) as the billing destination for all print data provided by the university, and the billing management unit 214 issues the corresponding billing destination ID. Then, the communication processing unit 211 transmits the billing destination ID to the image processing apparatus 10 as the billing destination information.

In step S410, the code image generation unit 114 (refer to FIG. 4) generates the code image 102 (refer to FIGS. 8A and 8B) including the user input information, the attribute information, and the billing destination information.

In step S411, the document processing unit 115 (refer to FIG. 4) performs processing of assigning the code image 102 generated by the code image generation unit 114 to the print data of the task A-1, and obtaining the coded print data. More specifically, processing of pasting the code image 102, which is a QR code (registered trademark), is performed on all pages of the print data of the task A-1.

In step S412, the image forming processing unit 116 (refer to FIG. 4) controls the image forming unit 16 to print the coded print data and output the coded print data as the document with code, which is the paper document.

As described above, by the procedure of steps S401 to S412, the user acquires the document with code corresponding to the task A-1. In this example, the user returns home once, writes the answer to the task A-1 in the document with code, then moves to the same store again, uses the image processing apparatus 10, and uses the scanning service.

### Scanning Document With Code and Billing Processing

In step S501 shown in FIG. 7, the input processing unit 113 accepts the selection (designation) of the submission scanning service in the same manner as the selection of the submission printing service in step S401 of FIG. 6. More specifically, in the image processing apparatus 10, two buttons for respectively designating the “submission scanning service” and the “normal scanning service” are displayed on the touch panel, and a fact that the “submission scanning service” button is pressed of the two buttons is accepted as the selection of the submission scanning service.

In step S502, the input processing unit 113 receives a scan instruction from the user. In this example, the user sets the task A-1 after filling out as a manuscript in the image processing apparatus 10, and presses the “scan execution” button displayed on the touch panel to perform the scan instruction.

In the “normal scanning service”, the “scan execution” button cannot be pressed unless the user has made a deposit, so that the scan instruction cannot be performed. On the other hand, in the “submission scanning service”, even in a state in which the billing to the billing destination is not completed, the “scan execution” button can be pressed to instruct scanning. Then, in the “submission scanning service”, as will be described later in step S505, step S509, and step S513, it is determined whether or not the current scan is the target of the billing to the billing destination and whether or not billing to the billing destination for the current scan is necessary, in a procedure after the scan data is generated.

In step S503, the image reading processing unit 117 (refer to FIG. 4) controls the image reading unit 17 to scan the manuscript to generate the scan data.

In step S504, the code image reading unit 118 (refer to FIG. 4) extracts the code image 102 from the generated scan data and reads various information included therein. In this example, since the code image 102 includes the user input information input at the time of printing, the transmission destination information received from the server apparatus 20, the deadline information, the restriction information, and the billing destination information, the code image reading unit 118 reads the information to associate with the scan data.

In step S505, the billing target determination unit 119 sorts data to be the target of the transmission to the designated transmission destination and the target of the billing to the billing destination from the generated scan data. In this example, in the scan data generated by the image reading processing unit 117, only the page to which the code image 102 is assigned is sorted as the target of the billing. For pages to which the code image 102 is not assigned, a text indicating that the page is not the target of transmission to the transmission destination and the target of the billing to the billing destination is displayed together with the thumbnail images of the pages and is notified to the user. Then, only the page sorted as the target is reorganized as transmission scan data. At this time, in a case where the fee for scanning a page that is not the target is charged to the user and payment is made, the page to which the code image 102 is not assigned may be the target of transmission to the transmission destination.

Further, in a case where the generated scan data does not include any code image 102, that is, in a case where no code image 102 is assigned to the manuscript, it is determined that the current scan is not the target of the billing. As described above, in the present exemplary embodiment, the fact that the code image 102 is assigned to the manuscript or that the code image 102 is included in the scan data is an example of the predetermined billing condition.

In step S506, the input processing unit 113 accepts the input of the student ID number of the user and password as the user input information. Here, in a case where the user input information read from the code image 102, that is, the user input information in a case where the printing service is used is different from the user input information input in step S506, the billing target determination unit 119 may determine that the current scan is not the target of the billing.

In step S507, the communication processing unit 111 requests the server apparatus 20 for the print data ID read from the code image 102 and the transmission history information related to the user ID.

In step S508, the history management unit 215 extracts the transmission history corresponding to the designated print data ID and the user ID in response to the request from the image processing apparatus 10, and transmits the transmission history via the communication processing unit 211.

In step S509, the billing target determination unit 119 refers to the user input information, the deadline information, and the billing restriction information read from the code image 102, and determines the target of the billing in a case where the predetermined billing condition is satisfied. As a more specific example, the billing target determination unit 119 makes, as the billing condition, a fact that the user ID read from the code image 102 belongs to the user who is taking the class A by referring to the billing restriction information for each user. Further, for example, the billing target determination unit 119 makes, as the billing condition, a fact that the number of submissions (transmissions) of the task A-1 by the user identified by the user ID is equal to or less than the predetermined number of times by referring to the multiple billing restriction information. Then, the billing target determination unit 119 uses the user ID or the transmission history acquired based on the user ID to determine whether or not the billing conditions are satisfied, and determines the target of the billing in a case where the billing conditions are satisfied. As in the examples, the billing is managed for each user by providing a billing condition related to the user ID, which is an example of the user identification information, and determining the target of the billing.

Further, other conditions may be used as the billing conditions in step S509. For example, the billing condition may be that the date at which the current scan is instructed is before the scan deadline by referring to the scan deadline information.

In a case where it is determined in step S509 that the current scan is not the target of the billing, a fact that the current scan is not the target of the billing is notified to the user by displaying, for example, text, and the process ends. That is, the fee for scan, billing to the billing destination, and transmission to the transmission destination of the scan data are not performed.

In step S510, the input processing unit 113 accepts a transmission instruction from the user. In this example, the user confirms the content and number of pages of the transmission scan data displayed as a thumbnail image, a delivery destination information displayed as text, and then presses a “transmission execution” button displayed on the touch panel to perform the transmission instruction.

In step S511, the communication processing unit 111 transmits the transmission scan data, the user input information input in step S506, and various information read from the code image 102 in step S504 to the server apparatus 20.

In step S512, the billing management unit 214 (refer to FIG. 5) determines the billing destinations of the fee for printing and the fee for scanning based on the billing destination information received together with the scan data from the image processing apparatus 10. In this example, the university withdrawal account account1 is determined as the billing destination based on the billing destination ID received as the billing destination information.

In step S513, the billing management unit 214 determines that the target of the billing in a case where the predetermined billing condition related to the scan data received from the image processing apparatus 10 is satisfied. In this example, the determination is performed by using, as the billing condition, a condition that the degree of similarity between the received scan data and the print data corresponding to the scan data exceeds the threshold value predetermined by the provider. In addition, the billing management unit 214 may perform the determination using other billing conditions described with reference to FIG. 5.

In a case where it is determined in step S513 that the current scan is not the target of the billing, the fact that the current scan is not the target of the billing is notified to the user by displaying, for example, text, and the process ends. That is, the fee for scan, billing to the billing destination, and transmission to the transmission destination of the scan data are not performed.

In step S514, the communication processing unit 211 transmits the scan data received from the image processing apparatus 10 to the transmission destination according to the transmission destination information. In this example, processing of storing the transmission scan data in the folder A provided in the image processing apparatus 10 is performed.

In step S515, the billing management unit 214 performs the billing processing to the determined billing destination. In this example, withdrawal processing is performed for the university withdrawal account account1. In addition to the configuration in which the billing processing is performed each time the user executes printing and scanning as in the above example, a configuration may be provided in which the fee for a predetermined period (for example, one month) are collected for each billing destination and the billing processing is collectively performed after the period ends.

As described above, by the processes in steps S501 to S515, the task A-1 after filling out is scanned and submitted to the university (transmission to the folder A). In addition, the fee for printing and the fee for scanning are collectively managed and billing to the withdrawal account account1 of the university, which is the billing destination.

As in this example, the code image 102 containing the billing destination information is assigned to the print data, the print data is printed as the document with code, the billing destination information is read and in a case where scanning the document with code, and the billing destination is determined based on the billing destination information, thereby reducing the time and effort of the user.

In the above example, the user used the printing service and the scanning service by the image processing apparatus 10 installed in the same store, but each service may be used by the image processing apparatus 10 installed in a different store.

Here, in a case where the distance between a store in which the printing service is used and a store in which the scanning service is used is noticeably far away, for example, in a case where the printing service is used in Tokyo and the scanning service is used in the United States, there is a possibility that the user who uses the printing service and the user who uses the scanning service are different from each other, so that billing which is not intended by the provider may be performed due to mischief or misuse. Therefore, the information on the store in which the printing service is used or the apparatus identification information of the image processing apparatus 10 is assigned to the code image 102, and the billing processing may be configured to be not performed in a case where the store or the apparatus which has used the printing service is different from the store or the apparatus which has used the scanning service.

Further, in the above example, the case where the information processing system 1 is used for the submission of the task A-1 with the provider as a university and the user as a student is described, but the target to which the information processing system 1 is applied is not limited. For example, as long as a case where submission to the provider is expected by printing the paper document, editing by filling in content, and scanning as in submission of an interview sheet between a hospital that is the provider and a patient who is the user, and submission of various application forms between a local government that is the provider and a resident who is the user, the case may be the target to which the information processing system 1 is applied.

### MODIFIED EXAMPLES

### Submission Service and Normal Service

In the above example, the configuration in which the user selects one of the “submission″/“normal” services in a case of using the service has been described, but the configuration may be used in which the “submission″/“normal” services are switched based on the determination result of the image processing apparatus 10. More specifically, in a case where it is determined to be not the target of the billing in step S407, step S505, step S509 or step S513, in a case where the code image 102 is not included in the scan data (the manuscript is not the document with code) in step S504, or in a case where the billing to the billing destination of the fee for scanning is not performed as in a case where the billing destination information is not included in the code image 102, the process is shifted to the normal scanning service, and the fee for scanning may be charged to the user through display on the display unit 15. In this case, the image processing apparatus 10 transmits the generated scan data to the transmission destination in response to payment made by the user. The display unit 15 may display that the service is not the target of the billing, and may recommend the use of the normal scanning service by displaying text or the like. Similarly, in a case where billing to the billing destination of the fee for printing is not performed, shifting to the normal printing service or usage of the normal printing service may be recommended.

### Billing Destination Information

In the above example, the billing destination of the fee for scanning is determined using the billing destination ID as the billing destination information, but the billing destination information may be another information. For example, a credit card number, an account number, or the like, which is set as the billing destination, may be used as billing destination information. Further, for example, in a case where the print data ID or the print job ID is used as the billing destination information, the print data corresponding to the scanned paper document is specified, and the billing destination associated with the print data is determined. Further, in a case where only one billing destination is set from the provider, information identifying the provider such as the provider ID may be used as the billing destination information. Furthermore, in a case where the billing destination is set to correspond to the transmission destination and, for example, in a case where setting “the account account1 is set as the billing destination in a case where the folder A is set as the transmission destination” is performed, the delivery destination information may be used as the billing destination information.

As described above, the billing destination information may be any information used to determine the billing destination set by the provider as the target of the billing processing, and, in the present exemplary embodiment, the billing destination information may be associated with the billing destination managed by the server apparatus 20.

### Generation of Document With Code

In the above example, the code image 102 is assigned to the print data to obtain the coded print data, and the document with code is generated by printing the coded print data. However, a method for generating the document with code is not limited thereto. For example, the document with code may be generated by printing the print data without assigning the code image 102, outputting the paper document which does not include the code image 102, and then pasting the code image 102 printed as a separate sticker or the like.

### Reading Code Image 102

Further, in the above example, the code image 102 included in the scan data is extracted and the billing destination information or the like is read, but a method of reading is not limited thereto. For example, the code image 102 may be read by a code reader or the like provided in the image processing apparatus 10.

### Billing of Fee for Printing

In the above example, a configuration is provided in which, in a case where the scanning service is used, the fee for printing the print data and the fee for scanning the paper document generated by printing are collected and billing is performed to the billing destination, but the billing of the fee for printing may be performed by another procedure. For example, in the middle of or at the end of the sequence chart shown in FIG. 6, a step in which the billing management unit 214 performs billing on the fee for printing to the billing destination may be provided. However, as in the above example, the billing is performed by collecting the fee for printing and the fee for scanning, so that the time and effort of the provider due to the management of the billing are reduced, compared with a case where the billing is performed by different procedures.

Further, in the above example, the normal printing service and the submission scanning service may be used in combination. That is, each service may be used with the fee for printing as the payment of the user and the fee for scanning as the billing to the billing destination.

### Apparatus That Performs Various Processing

In the information processing system 1 to which the present exemplary embodiment is applied, an apparatus is not limited which performs various processing of generating the code image 102 and assigning the code image 102 to the print data, determining the billing condition, determining the billing destination, performing the billing to the billing destination, and transmitting the scan data to the transmission destination. For example, the server apparatus 20 may generate the code image 102, assign the code image 102 to the print data, and extract the code image 102 from the scan data. Further, for example, the image processing apparatus 10 may determine the billing destination, perform the billing to the billing destination, and transmit the scan data to the transmission destination.

### Provision of Program

The processing performed by each apparatus of the information processing system 1 to which the present exemplary embodiment is applied is prepared as, for example, a program such as application software. Also, it is possible to provide the program not only by a communication means but also by being stored in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a code assignment section that makes a document with code by assigning a code image to a first electronic document, the code image including billing destination information for determining a billing destination of a fee for reading the document with code;
a printing section that prints the document with code as a paper document;
a reading section that reads the document with code to generate a corresponding second electronic document, and transmits the second electronic document to a designated transmission destination;
a code reading section that reads information from the code image in a case where the document with code is read by the reading section; and
a billing section that performs billing to the billing destination for the fee for reading based on the billing destination information read by the code reading section.

2. The information processing system according to claim 1,
wherein the code assignment section acquires the billing destination information associated with the first electronic document by a provider of the first electronic document, and assigns the code image.

3. The information processing system according to claim 2, further comprising:
a storage section that stores the first electronic document and the billing destination information in association with each other, wherein
the code assignment section acquires the billing destination information stored in the storage section, and assigns the code image.

4. The information processing system according to claim 2,
wherein the billing section collects a fee for reading and a fee for printing by the printing section, and performs billing to the billing destination.

5. The information processing system according to claim 1,
wherein the billing section performs billing to the billing destination for the fee for reading in a case where a predetermined billing condition related to the document with code or the second electronic document is satisfied.

6. The information processing system according to claim 5,
wherein the code image assigned by the code assignment section includes attribute information that is information different from the billing destination information and is information indicating attributes of the paper document, and
the billing condition is a condition related to the attribute information read from the code image.

7. The information processing system according to claim 6,
wherein the attribute information is identification information for identifying a user, which is input by the user in a case where the paper document is printed.

8. The information processing system according to claim 6,
wherein the attribute information is information set in the first electronic document by a provider of the first electronic document.

9. The information processing system according to claim 5,
wherein the billing condition is a condition related to a degree of similarity between the first electronic document and the second electronic document.

10. The information processing system according to claim 9,
wherein the billing condition is a condition that the degree of similarity exceeds a threshold value predetermined by a provider of the first electronic document.

11. The information processing system according to claim 5,
wherein the reading section does not transmit the second electronic document to the transmission destination in a case where the billing section does not perform billing to the billing destination.

12. The information processing system according to claim 6,
wherein the reading section does not transmit the second electronic document to the transmission destination in a case where the billing section does not perform billing to the billing destination.

13. The information processing system according to claim 7,
wherein the reading section does not transmit the second electronic document to the transmission destination in a case where the billing section does not perform billing to the billing destination.

14. The information processing system according to claim 8,
wherein the reading section does not transmit the second electronic document to the transmission destination in a case where the billing section does not perform billing to the billing destination.

15. The information processing system according to claim 9,
wherein the reading section does not transmit the second electronic document to the transmission destination in a case where the billing section does not perform billing to the billing destination.

16. The information processing system according to claim 10,
wherein the reading section does not transmit the second electronic document to the transmission destination in a case where the billing section does not perform billing to the billing destination.

17. The information processing system according to claim 11, further comprising:
a charging section that charges a user for a fee for reading in a case where the billing section does not perform billing on the billing destination, wherein
the reading section transmits the second electronic document to the transmission destination in a case where the fee for reading charged by the charging section is paid by the user.

18. The information processing system according to claim 1, wherein the code image assigned by the code assignment section includes transmission destination information for designating the transmission destination, and
the reading section transmits the second electronic document to the transmission destination designated based on the transmission destination information read by the code reading section.

19. An information processing apparatus comprising:
a processor configured to:
print a document with code that is a paper document to which a code image is assigned;
read the document with code to generate a corresponding electronic document, and transmit the electronic document to a designated transmission destination;
read billing destination information for determining a billing destination of a fee for reading the document with code from the code image in a case where the document with code is read; and
perform billing to the billing destination for the fee for reading based on the read billing destination information.

20. A non-transitory computer readable medium storing a program causing a computer to execute:
a function of printing a document with code that is a paper document to which a code image is assigned;
a function of reading the document with code to generate a corresponding electronic document, and transmitting the electronic document to a designated transmission destination;
a function of reading billing destination information for determining a billing destination of a fee for reading the document with code from the code image in a case where the document with code is read; and
a function of performing billing to the billing destination for the fee for reading based on the read billing destination information.
